(19) United States
(12) Patent Application Publication
(10) Pub. No.: US 2024/0059227 A1
(43) Pub. Date: Feb. 22, 2024

(54) Storage Element

(71) Applicant: Paul Hettich GmbH & Co. KG, Kirchlengern (DE)

(72) Inventors: Oscar GARCIA, San Sebastian (ES); Iker LOPETEGI, Zarautz (ES); Benjamin BEXTERMOELLER, Melle (DE); Arnold GURR, Osnabrueck (DE); Ander MARTINEZ, Donostia (ES)

(21) Appl. No.: 18/265,759

(22) PCT Filed: Dec. 1, 2021
(86) PCT No.: PCT/EP2021/083770

§ 371 Date: Jun. 7, 2023

(30) Foreign Application Priority Data
Dec. 8, 2020 (DE) 10 2020 132 675.0

(51) Int. Cl. B60R 7/06; B60N 3/00

(52) U.S. Cl. CPC B60R 7/06; B60N 3/002; B60R 2011/0005

(57) ABSTRACT

A storage element which can be installed in a vehicle interior, in particular in a dashboard, has a tray and a lifting and lowering pull-out device with a body rail which is fixable in a stationary manner to a side wall of the vehicle interior, a tray rail with the tray arranged thereon, and two center rails which are arranged displaceably and pivotably with the body rail and the tray rail and are coupled to one another displaceably relative to one another in the direction of their longitudinal axis. The body rail is pivotably coupled to a first center rail via a first pivot guide web and the tray rail is pivotably coupled to a second center rail via a second pivot guide web. A stabilizing unit with a guide slot stabilizing the lifting and lowering movement of the tray rail and a guide element guided in the guide slot at least in a partial section of a lifting and lowering movement of the tray rail is arranged on the tray or the tray rail and the side wall of the vehicle interior or the body rail.

### BACKGROUND AND SUMMARY

The present invention relates to a storage element which can be installed in a vehicle interior, in particular in a dashboard.

Such storage elements are used to store vehicle documents, flashlights, maps or other objects and are installed, for example, in a storage opening of a dashboard of a vehicle interior.

Depending on the items stored on the tray, reliable movement may be difficult, especially when loaded with heavy items and/or unevenly distributed items.

The problem to be solved by the present invention is to further develop a storage element of the generic type in such a way that the movement sequence of the storage element is stabilised.

This problem is solved by a storage element with the features of the independent claim.

The storage element according to the invention, which can be installed in a vehicle interior, in particular in a dashboard, comprises a tray, as well as a lifting and lowering pull-out device with a body rail which is fixable in a stationary manner to a side wall of the vehicle interior, a tray with a tray rail arranged thereon, that is more particularly fixable in a stationary manner, and two center rails which are arranged displaceably and pivotably with the body rail and the tray rail and are coupled to one another displaceably relative to one another in the direction of their longitudinal axis.

The body rail is coupled to a first center rail via a first pivotal guide bar. The tray rail is coupled to a second center rail via a second pivotal guide web so that it can be swivelled together.

A stabilizing unit with a guide slot stabilizing the lifting and lowering movement of the tray rail and a guide element guided in the guide slot at least in a partial section of a lifting and lowering movement of the tray rail is arranged on the tray or the tray rail and the side wall of the vehicle interior or the body rail.

By providing such a stabilizing unit, the tray rail is additionally guided, in particular during the lifting and lowering movement, so that a safe movement sequence of the lifting and lowering pull-out device is ensured even when the tray is loaded with heavy objects.

Advantageous embodiments of the invention are the subject of the dependent claims.

According to an advantageous embodiment, a first panel is attached to or moulded onto the tray or the tray rail, on which the guide element is arranged. Correspondingly, a second panel is attached or moulded to the side wall of the vehicle interior or the body rail, on which or through which the guide slot is formed.

According to an advantageous further development, two panels are attached to the side wall of the vehicle interior, between which the guide slot is formed.

In a further advantageous embodiment, a first panel is attached to or moulded onto the tray or the tray rail, on which or through which the guide slot is formed. Correspondingly, a second panel is attached or moulded to the side wall of the vehicle interior or the body rail, on which the guide element is arranged.

According to a preferred embodiment, the guide element is formed as a wheel, bolt or sliding block and thus ensures reliable support of the tray rail during the lifting and lowering movement.

In a further advantageous embodiment, the storage element comprises a cover concealing the tray in a closed position of the storage element, wherein the second pivotal guide web is coupled to a pivotal mechanism for pivoting the cover.

In this way, the objects stored in the storage element are secured against falling out during travel when the cover is closed. Because of the connection of the cover to the second pivotal guide bar, the opening of the cover is directly coupled with the movement of the tray of the storage element.

In an advantageous further embodiment, the pivotal mechanism comprises a first lever rigidly attached to the cover and coupled to the tray rail or tray via a rotation axis, and a second lever pivotably coupled to the first lever at a first end via a pivotal joint and pivotably coupled to an end of the second pivotal guide web at a second end.

According to a further advantageous embodiment, the body rail, the tray rail and the center rails each comprise a guide groove extending in the direction of their longitudinal axis, in which respective guide bolts are guided.

In a preferred further embodiment, the displaceably coupled center rails are coupled with each other in a parallel offset. One of the guide bolts of the first center rail is guided in the guide groove of the second center rail. Correspondingly, one of the guide bolts of the second center rail is guided in the guide groove of the first center rail.

This coupling ensures a reliable longitudinal displacement of the two center rails in relation to each other.

In a further preferred embodiment, the tray is coupled to a motor for motor-driven movement of the tray.

According to a preferred further development, a shaft drivable by the motor is coupled to a first end of the first pivotal guide web rotatably fixed to the body rail.

The arrangement of the motor at the first end of the first pivotal guide web is particularly advantageous because the motor thus disappears in the body below the tray when the tray is retracted.

In the following, preferred embodiments are explained in more detail with reference to the drawings.

### BRIEF DESCRIPTION OF THE DRAWINGS

FIG. 1 is a schematic perspective view of an embodiment of a storage element according to the invention, installed in a tray compartment of a dashboard of a vehicle interior;

FIG. 2 is a side view of the storage element with lifting-lowering pull-out device in an initial position retracted into the tray compartment as shown in FIG. 1;

FIG. 3 is a representation corresponding to FIG. 1 with the tray rail shifted linearly to the body rail;

FIG. 4 is a side view of the storage element in the position shown in FIG. 3;

FIG. 5 is a detailed view of the detail marked V in FIG. 4 to show the threading of the guide element into the guide slot of the stabilizing unit;

FIG. 6 is a representation corresponding to FIG. 1 in a lowered end position of the tray and the tray rail;

FIG. 7 is a side view of the storage element in the position shown in FIG. 5;

FIG. 8 is a detailed view of the section marked VIII in FIG. 7;

FIG. 9 is a schematic perspective view of a further embodiment of a storage element according to the invention, installed in a tray compartment of a dashboard of a vehicle interior, with a cover closing the tray compartment;

FIG. 10 is a side view of the storage element with lifting and lowering pull-out device in an initial position retracted into the tray compartment as shown in FIG. 9 and motor-driven lifting and lowering pull-out device;

FIGS. 11 and 12 represent the storage element corresponding to FIGS. 3 and 4 according to FIGS. 9 and 10;

FIGS. 13 and 14 represent the storage element corresponding to FIGS. 6 and 7 according to FIGS. 9 and 10;

FIG. 15 is a perspective view of the storage element with lowered tray and motor-driven raising and lowering pull-out device; and

FIG. 16 is a top view of the motorized storage element in the position shown in FIG. 15.

### DETAILED DESCRIPTION OF THE DRAWINGS

In the following description of figures, terms such as top, bottom, left, right, front, rear, etc. refer exclusively to the exemplary representation and position of the storage element, the raising and lowering pull-out device, the dashboard, the body rail, tray rail, center rail, pivotal guide web and the like selected in the respective figures. These terms are not to be understood restrictively, i.e. these references may change due to different working positions or the mirror-symmetrical design or the like.

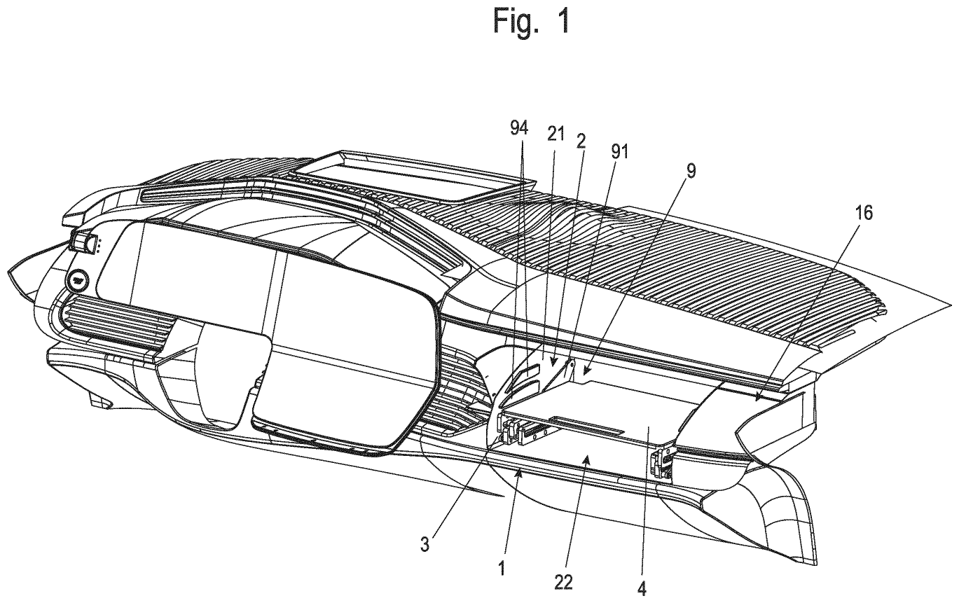

In FIG. 1, the reference sign 1 indicates a first embodiment of a storage element according to the invention which is installed in a tray compartment 2 of a dashboard 16 of a vehicle interior which is open towards the passenger compartment of the vehicle.

The storage element 1 comprises a tray 4 which is movable out of the tray compartment 2 of the dashboard 16 and lowered by means of a raising/lowering pull-out device 3 of the storage element 1. The lifting-lowering-extension device 3 can also be arranged in such a way that the tray 4 is movable out and raiseable.

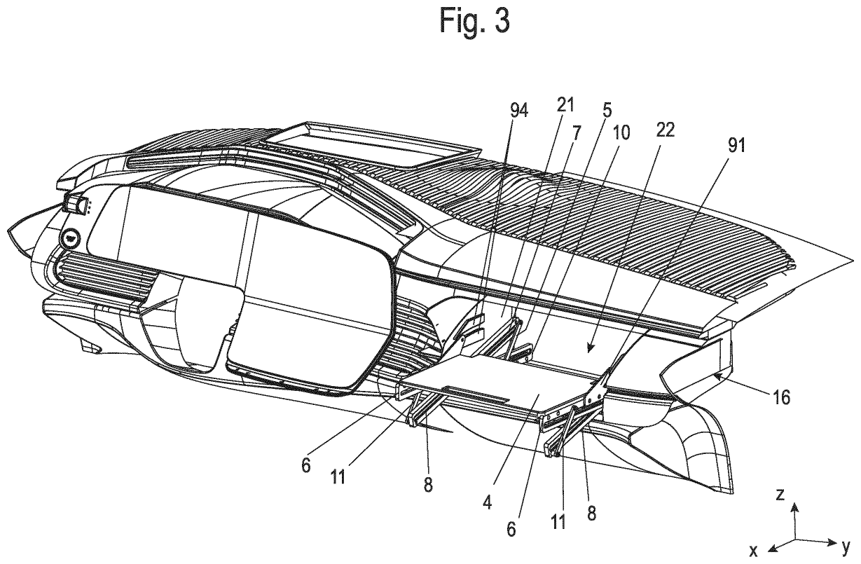

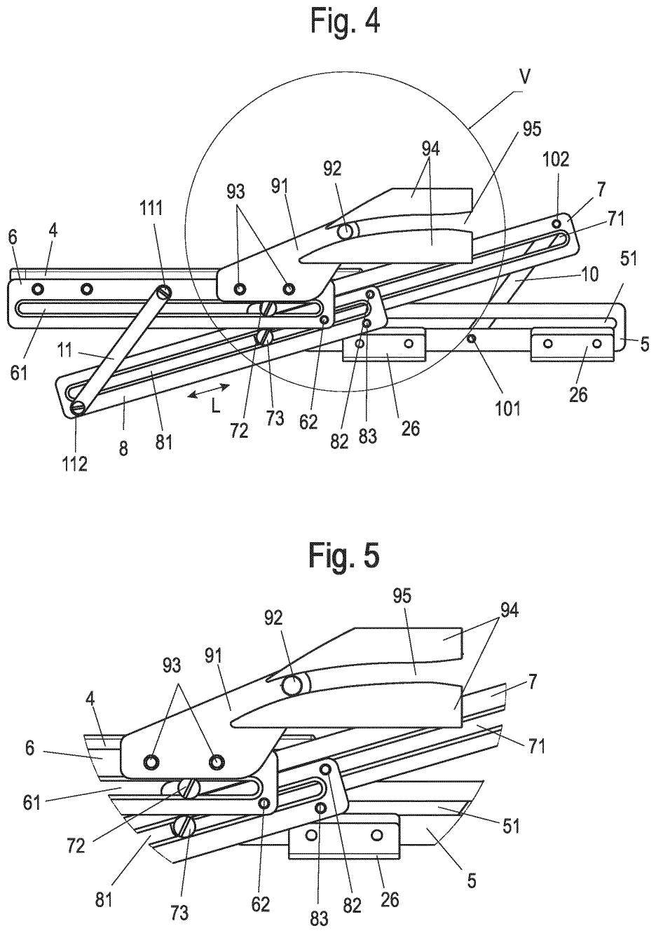

In FIGS. 3 and 4, the storage element 1 with the lifting and lowering pull-out device 3 is shown in a position in which the tray 4 is extended linearly from the tray compartment 2 of the dashboard 16, here in the horizontal X-direction.

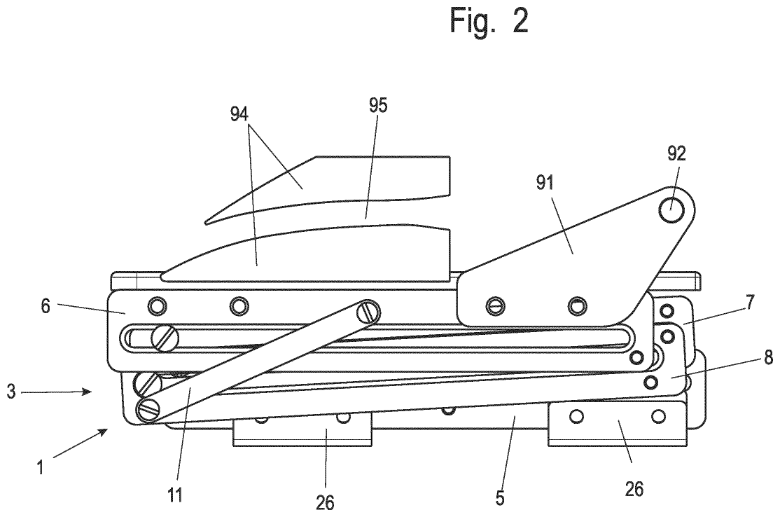

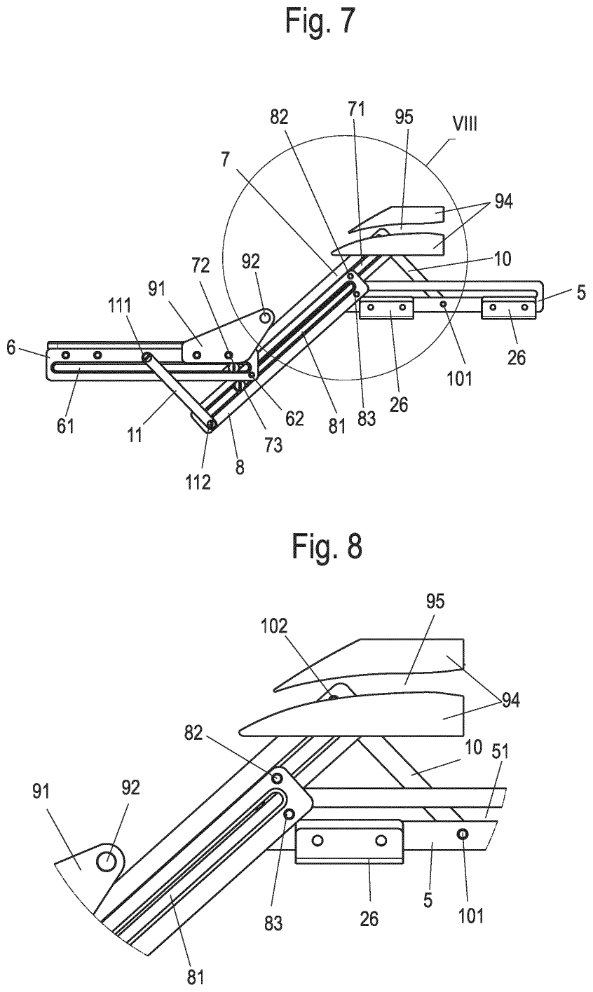

As shown in FIGS. 2 to 4 and 7, the lifting and lowering pull-out device 3 comprises a body rail 5 fixed in a stationary manner to a side wall 21 of the tray compartment 2 by means of fastening elements 26, a tray rail 6 which is fixable in a stationary manner to the tray 4, and two center rails 7, 8 which are arranged displaceably and pivotably with the body rail 5 and the tray rail 6 and are coupled to one another so as to be displaceable relative to one another in the direction of their longitudinal axis L.

The body rail 5 is thereby pivotably coupled to a first center rail 7 via a first pivotal guide web 10.

In a corresponding manner, the tray rail 6 is pivotably coupled to a second center rail 8 via a second pivotal guide web 11.

As can be seen clearly in FIG. 4, a first end 101 of the first pivotal guide web 10 is preferably attached to the body rail 5 so that it can pivot approximately centrally, as viewed in the pull-out direction X.

A second end 102 of the first pivot guide web 10 is rotatably attached to a rear end of the first center rail 7 in the pull-out direction X.

In a corresponding manner, a first end 111 of the second pivotal guide web 11 is pivotably attached to the tray rail 6 via a rotation axis 113 approximately centrally, and a second end 112 of the second pivotal guide web 11 is pivotably attached to a front end of the second center rail 8 in the pull-out direction X.

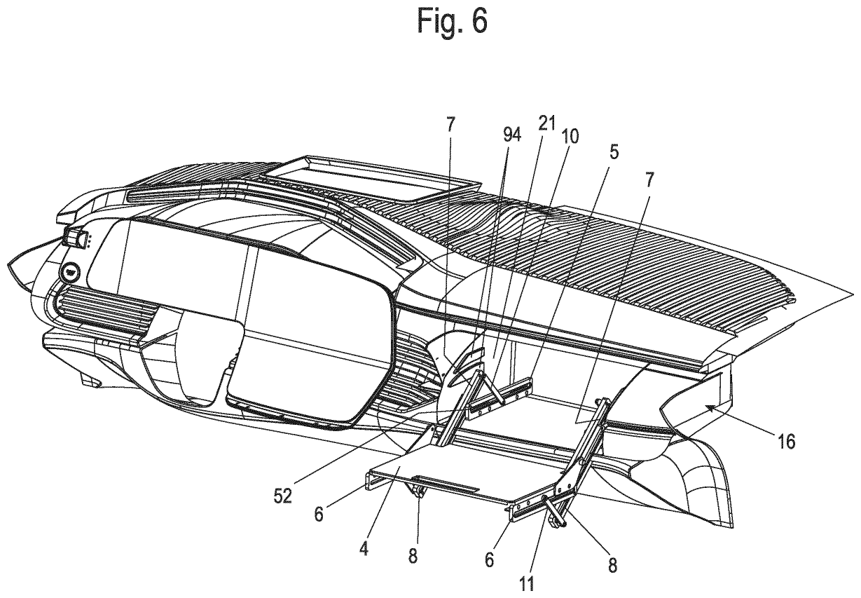

A guide bolt 52 is attached to a front end of the body rail 5 in the pull-out direction X, which is guided in a guide groove 71 of the first center rail 7, as shown as an example in FIG. 6.

Accordingly, a guide bolt 62 of the tray rail 6 is guided in a guide groove 81 of the second center rail 8.

Furthermore, a first guide bolt 72 and a second guide bolt 73 are attached to the front end of the first center rail 7 in the pull-out direction X.

The first guide bolt 72 is guided in a guide groove 61 of the tray rail 6. The second guide bolt 73 of the first center rail 7 is guided in the guide groove 81 of the second center rail 8.

Furthermore, a first guide bolt 82 and a second guide bolt 83 are attached to a rear end of the second center rail 8 in the pull-out direction X. The first guide bolt 82 is guided in the guide groove 71 of the first center rail 7. The second guide bolt 83 is guided in the guide groove 51 of the body rail 5.

As further shown in FIGS. 1 to 8, the storage element 1 comprises a stabilizing unit 9 arranged on the tray 4 or the tray rail 6 and the side wall 21 of the tray compartment 2 or the body rail 5.

In this embodiment example, the stabilizing unit 9 comprises a guide slot 95 stabilizing the lifting and lowering movement of the tray rail 6 and a guide element 92 guided in the guide slot 95 at least in a partial section of a lifting and lowering movement of the tray rail 6.

In the embodiments shown, a first panel 91 is attached to the tray rail 6, on which the guide element 92, formed here as a wheel, is arranged.

In this embodiment, two second panels 94 are attached to the side wall 21 of the tray compartment 2, between which the guide slot 95 is formed. The guide slot 95 is shaped in such a way that when the tray rail 6 is moved from the fully retracted position shown in FIG. 2, the guide element 92 can be retracted into a slightly funnel-shaped entry area and transitions into a curve that slopes in the pull-out direction X to assist in lowering the tray rail 6 and thus the tray 4.

A kinematic reversal of this arrangement is also contemplated, so that the guide element 92 would be arranged on the side wall 21 of the tray compartment 2 and the guide slot 95 would be arranged correspondingly on the panel 91.

Instead of the guide element 92 formed as a wheel, it is also contemplated to form the guide element 92 as a bolt or sliding block.

In the exemplary embodiments shown here, the panel 91 is fixed to the tray rail 6 with fastening elements 93.

The guide grooves 51, 61, 71, 81 extend in the direction of the longitudinal axis L of the respective rails, i.e. the body rail 5, the tray rail 6 and the two center rails 7, 8.

To enable the guide bolts 73, 82 of the two center rails 7, 8 to engage with each other in respective guide grooves 71, 81, the displaceably coupled center rails 7, 8 are coupled to each other in a parallel offset manner.

As shown in FIGS. 6 to 8, when the tray rail 6 is lowered, the guide element 92 is disengaged from the guide slot 95.

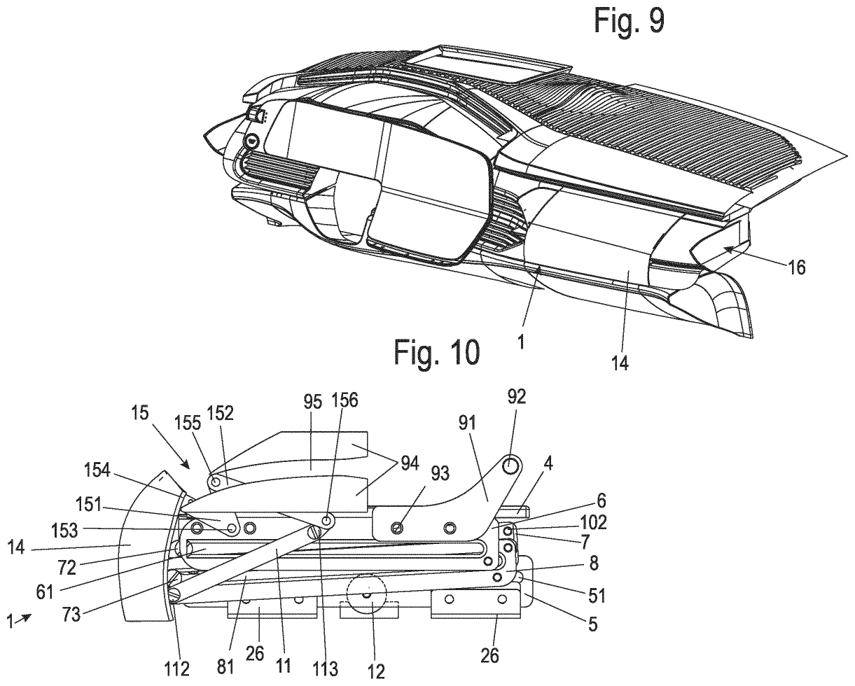

In FIG. 9, the reference sign 1 indicates a second embodiment of a storage element according to the invention which is installed in a tray compartment 2 of a dashboard 16 of a vehicle interior which can be closed towards the passenger compartment of the vehicle by a cover 14.

Except for the cover 14 and its connection to the lifting-lowering-extension device 3, the storage element 1 corresponds to the embodiment variant previously described with reference to FIGS. 1 to 8.

The pivotal mechanism 15 for pivoting the cover 14 comprises a first lever 151 rigidly attached to the cover 14, the first end 154 of which is attached to the cover 14 and which is coupled to the tray rail 6 via a rotation axis 153, for example in the form of a pin projecting from the side wall of the tray rail 6.

An end of this first lever 151 remote from the cover 14 serves as a pivotal joint 155 for connecting a second lever 152, which is formed here as a rectilinear web and whose second end 156 is pivotably coupled to a first end 111 of the second pivotal guide web 11, which extends behind an axis of rotation 113 of the second pivotal guide web 11 arranged on the tray rail 6.

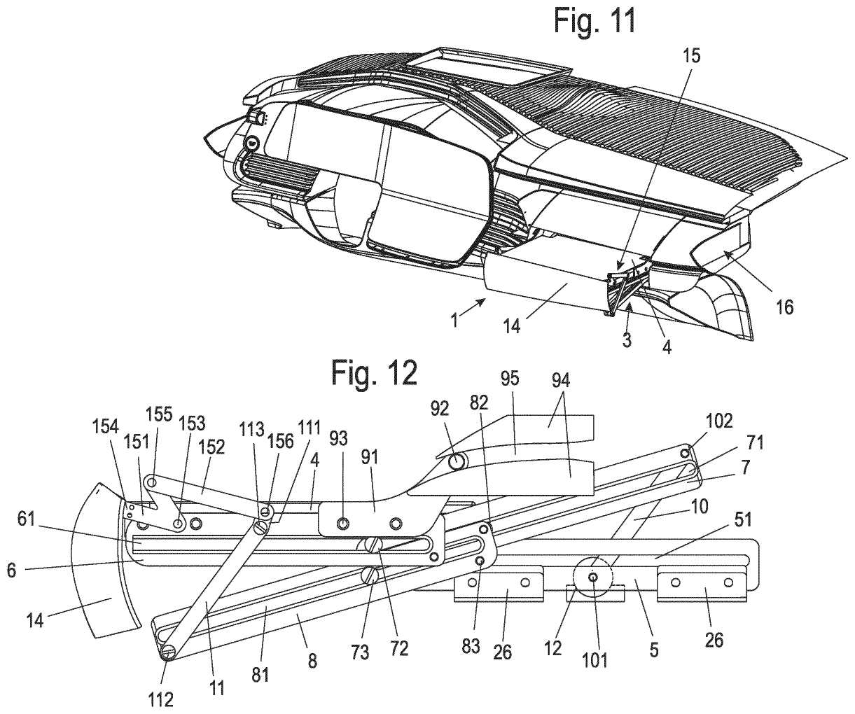

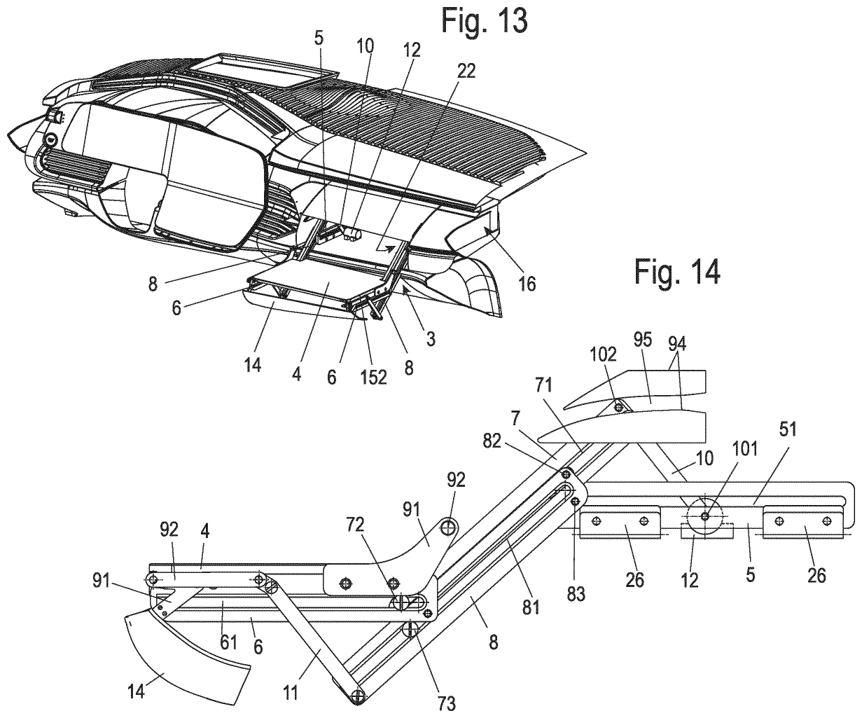

The tray 4 can be moved out of the tray compartment 2 of the dashboard 16 in such a way that, for example, by reaching under and pulling on the cover 14 from the position shown in FIG. 9 via the position shown in FIGS. 11 and 12, in which the tray 4 has initially only been moved horizontally out of the tray compartment 2 of the dashboard 16, to the position shown in FIGS. 13 to 16 in which the tray 4 is lowered to below a base of the tray compartment 2 by the inclination of the center rails 7, 8.

In the position shown in FIGS. 11 and 12, the cover 14 has already pivoted from its initial vertical position to an inclined state.

In the lowered end position of the tray 4 shown in FIGS. 13 to 16, the cover 14 is pivoted to such an extent that it is positioned almost completely under the tray 4 and is therefore not in the way of loading or unloading the storage element.

As an additional option, in the embodiment according to FIGS. 9 to 16, the storage element 1 is shown to be motor-driven by a motor 12. However, a variant of this storage element 1 without a motor drive is also conceivable. The motor 12 can of course also be used in the variant of the storage element 1 according to FIGS. 1 to 8.

FIGS. 13 to 16 show the fully lowered position of the tray rail 6 or tray 4.

In this embodiment, a motor 12 is arranged on one of the two lifting-lowering-extension devices 3 arranged opposite each other.

In this case, a shaft drivable by the motor 12 engages a first end 101 of the first pivot guide web 10, which is rotatably fixed to the body rail 5.

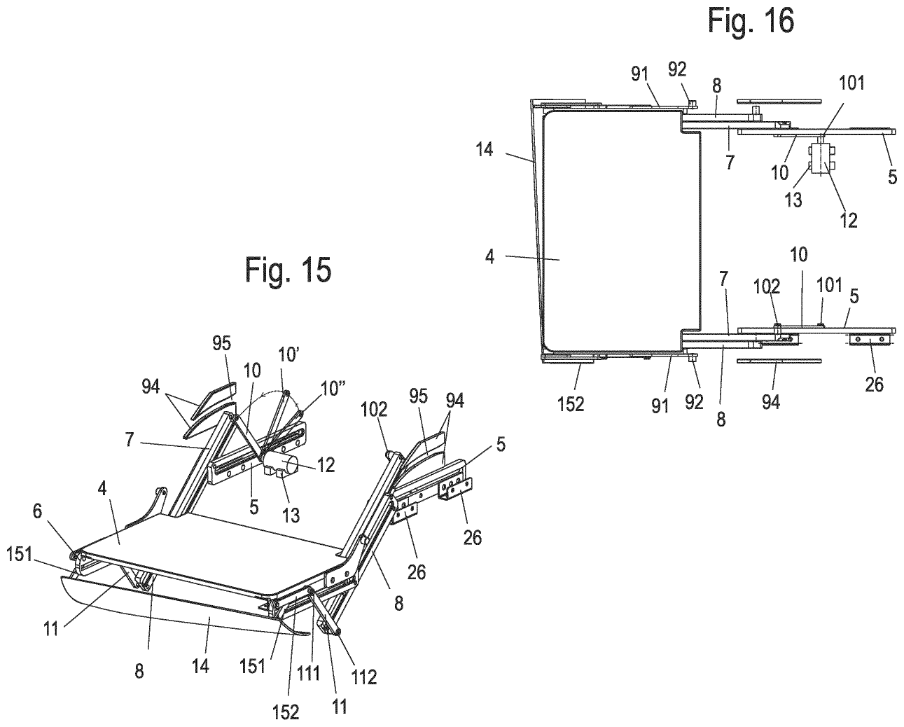

As schematically illustrated in FIG. 15, the motor 12 can thus move the pivotal guide web 10 from a dashed position (marked 10″), which corresponds to the retracted position of the lifting and lowering pull-out device 3 shown in FIGS. 9 and 10, via a middle position marked 10′, which corresponds to the horizontally extended position of the tray rail 6 shown in FIGS. 11 and 12, to the fully extended position of the pivotal guide web 10 analogous to FIG. 13.

FIG. 14 shows a side view of the position of the storage element 1 shown in FIG. 10 and FIG. 16 a top view.

The motor 12 is thereby preferably placed on a tray 13, which is preferably fixed to a bottom (not shown) of the interior 22 of the tray compartment 2.

The movement of the motor-driven tray 4 can be triggered, for example, via a button on the dashboard or via a remote control. It is also contemplated to control it via a wireless interface, such as in smart home applications, using common protocols (WLAN, Bluetooth, Zigbee, ZWave, . . . ) e.g. on the frequencies 433 MHz or 868 MHz, which allow operation by smartphone as well as by voice.

### LIST OF REFERENCE SIGNS

1 Storage element
2 Tray compartment
21 Side wall
22 Interior
26 Fastening element
3 Raising/lowering pull-out device
4 Tray
5 Body rail
51 Guide groove
52 Guide bolt
6 Tray rail
61 Guide groove
62 Guide bolt
7 First center rail
71 Guide groove
72 First guide bolt
73 Second guide bolt
8 Second center rail
81 Guide groove
82 First guide bolt
83 Second guide bolt
9 Stabilizing unit
91 First panel
92 Guide element
93 Fixing element
94 Second panel
95 Guide slot
10 First pivotal pivotal guide web
101 First end
102 Second end
11 Second pivotal guide web
111 First end
112 Second end
113 Rotation axis
12 Motor
13 Tray
14 Cover
15 Pivotal mechanism
151 First lever
152 Second lever
153 Rotation axis
154 First end
155 Pivotal joint
156 Second end
16 Dashboard
X Direction
Y Direction
Z Direction

1.-12. (canceled)

13. A storage element to be installed in a vehicle interior, comprising:
a tray;
a lifting and lowering pull-out device comprising a body rail that is fixable in a stationary manner to a side wall of the vehicle interior, a tray rail on which the tray is arranged, and two center rails which are arranged displaceably and pivotably with the body rail and the tray rail and are coupled to one another displaceably relative to one another in a direction of their longitudinal axis,
wherein the body rail is pivotably coupled to a first of the two center rails via a first pivotal guide web and the tray rail is pivotably coupled to a second of the two center rails via a second pivotal guide web; and
a stabilizing unit arranged on the tray or the tray rail and on the side wall of the vehicle interior or the body rail, the stabilizing unit comprising a guide slot that stabilizing a lifting and lowering movement of the tray rail and a guide element that is guided in the guide slot at least in a partial section of the lifting and lowering movement of the tray rail.

14. The storage element according to claim 13, wherein
a first panel, on which the guide element is arranged, is fastened or moulded on the tray or the tray rail, and
at least one second panel, on which or through which the guide slot is formed, is fastened or moulded on the side wall of the vehicle interior or the body rail.

15. The storage element according to claim 13, wherein
a first panel, on which the guide slot is formed, is fastened or formed on the tray or the tray rail, and
a second panel, on which the guide element is arranged, is fastened or formed on the side wall of the vehicle interior or the body rail.

16. The storage element according to claim 14, wherein
two panels, between which the guide slot is formed, are fastened to the side wall of the vehicle interior or the body rail or the tray or the tray rail.

17. The storage element according to claim 15, wherein
two panels, between which the guide slot is formed, are fastened to the side wall of the vehicle interior or the body rail or the tray or the tray rail.

18. The storage element according to claim 13, wherein
the guide element is formed as a wheel, bolt or sliding block.

19. The storage element according to claim 13, further comprising:
a cover concealing the tray in a closed position of the storage element, wherein
the second pivotal guide web is coupled to a pivotal mechanism for pivoting the cover.

20. The storage element according to claim 19, wherein
the pivotal mechanism comprises a first lever rigidly fixed to the cover and coupled to the tray rail or the tray via a rotation axis, and a second lever pivotably coupled at a first end to the first lever via a pivotal joint and pivotably coupled at a second end to an end of the second pivotal guide web.

21. The storage element according to claim 13, wherein
the body rail, the tray rail and the center rails each comprise a guide groove extending in the direction of their longitudinal axis, in which respective guide bolts are guided.

22. The storage element according to claim 13, wherein
the center rails, which are coupled to one another displaceably, are coupled to one another in a parallel offset manner,
one of the guide bolts of the first center rail is guided in the guide groove of the second center rail, and
one of the guide bolts of the second center rail is guided in the guide groove of the first center rail.

23. The storage element according to claim 13, further comprising:
a motor for a motor-driven movement of the storage element, wherein
the lifting and lowering pull-out device is coupled to the motor.

24. The storage element according to claim 23, wherein
a shaft drivable by the motor is coupled to a first end of the first pivotal guide web rotatably fixed to the body rail.

25. The storage element according to claim 13, wherein
the storage element is configured for installation in a dashboard of the vehicle interior.

26. A vehicle interior comprising at least one storage element according to claim 13, wherein the at least one storage element is built-in to a dashboard.
